(19) United States
(12) Patent Application Publication
(10) Pub. No.: US 2014/0363553 A1
(43) Pub. Date: Dec. 11, 2014

(54) Methods and Compositions for Preparation of Formed Food Products Using Fresh or Prepared Vegetables and/or Legumes and Other Ingredients

(71) Applicant: David Peters, Wellesley, MA (US)

(72) Inventor: David Peters, Wellesley, MA (US)

(21) Appl. No.: 14/298,879

(22) Filed: Jun. 6, 2014

Related U.S. Application Data
(60) Provisional application No. 61/832,757, filed on Jun. 7, 2013.

(51) Int. Cl. A23L 1/00; A23L 1/01

(52) U.S. Cl. CPC A23L 1/0014; A23L 1/0121; A23L 1/0047; A23L 1/0107
USPC 426/392; 99/517; 99/348; 99/345; 99/339

(57) ABSTRACT

Fresh potatoes, and/or other fresh vegetables or legumes, or any ingredients already frozen, processed, or otherwise prepared, are processed to make more healthful French fry products and other formed food items in any of a variety of shapes and flavor profiles while attaining the organoleptic qualities of traditional formed-food products.

### CROSS-REFERENCE TO RELATED APPLICATIONS

This application claims the benefit of provisional application No. 61/832,757, filed on Jun. 7, 2013.

### FIELD OF THE INVENTION

The present invention relates to the processing of fresh potatoes, and/or other vegetables and/or legumes, or of frozen, processed, or prepared potatoes, and/or other vegetables and/or legumes, and/or other ingredients, to make more healthful French fry products and other shaped or formed food items.

### BACKGROUND OF THE INVENTION

French fries and other prepared potato products are one of America's staple food products. There are nearly 10 billion pounds of Frozen Potatoes sold annually in the USA (Source: US Potato Board Sales Utilization Estimates, July 2011). Over 8 billion pounds of frozen potatoes are sold via foodservice channels alone, and nearly 50% of all purchases at McDonalds, Wendy's, and Burger King, the three largest quick service restaurant chains, include French fries or another fried potato product as part of the order (Source: NPD Group/Crest, 2009). French fries are often sold to consumers in a frozen form for preparation or heating at home as well as through wholesalers, distributors and directly to vendors for preparation and retail sale away from home.

French fries are one of America's favorite foods in part because they taste delicious and are available in a variety of shapes and sizes ranging from traditional French fries and steak fries, to waffle fries, tots, hash browns and various shapes that are intended to appeal to children, such as smiley faces and alphabet shapes.

French fries and other prepared potato products are generally considered unhealthy, because they lack substantial nutritional value with relatively low levels of vitamins and nutrients, and often include artificial colors and flavors to enhance taste and appearance. As an example, ingredients in the French fries served at a major national fast-food restaurant chain include natural beef flavor, dextrose, tertiary butylhdroquinone, dimethylpolysiloxane, and hydrogenated soybean oil.

The prior art of “Traditional French fry type” products as well as “Shaped Potato Products,” for instance the products and methods disclosed in U.S. Pat. Nos. 3,812,274, 3,085,020, 4,082,855, 4,276,314, 6,274,184, and 4,156,744, do not allow for or reference the possible incorporation of non-potato ingredients. Additionally, U.S. Pat. Nos. 6,274,184, 4,156,744, 3,399,062, and Publication No. 2003-0108654, variously disclose the use of dehydrated potato, riced potatoes, or potato flour, or a dry mix which is then rehydrated, or a combination of dehydration, aggregates, cellulose ether binding and rehydration process. Further, U.S. Pat. Nos. 7,090,884 and 4,109,012 respectively disclose utilizing a puree and fine-grinding approach and exclude oil frying, and a process of baking whole unpeeled potatoes, forming the product into a mealy dough, and emulsifiers and starch control agents to maintain a mealy internal consistency that is acceptable to consumers. Disadvantages of existing processes include difficulty in achieving traditional French fry organoleptic qualities that are critical for consumer enjoyment, introducing a variety of other chemicals, processing aids or other ingredients, some of which may be artificial, into the finished product.

American consumers are becoming increasingly conscious of the risks associated with unhealthy eating, and are beginning to embrace the need to include a greater amount of healthy vegetables and legumes and other natural foods as part of a well balanced diet. As an example, First Lady Michelle Obama has helped to elevate awareness through her “American Grown” vegetable garden on the South Lawn of the White House, and the “Let's Move” initiative that is focused on fighting childhood obesity and on promoting healthier, natural and whole foods.

While consumers are searching for foods with better nutritional content, they have limited time for preparation and they and their children are not willing to compromise taste. French fries, in all of their forms and shapes, are generally enjoyed for their unique organoleptic qualities including a crispy exterior, and tender but firm and mealy interior texture. Conventional methods of preparation involve extended frying times and result in relatively high levels of fat. For example, the major frozen retail brands utilize a fry time typically 45-120 seconds long prior to freezing and distributing their products. McDonalds fries their French fries for exactly 3 minutes and 10 seconds on premises.

Thus, there exists a consumer need for healthier French fry and chip products that possess the critical organoleptic and other visual qualities that consumers demand from traditional French fry and chip products, and which have increased amounts of naturally occurring vitamins and minerals, protein, fiber and other inherent nutritional qualities, while reducing or greatly reducing the amount of fat, carbohydrates, and/or sodium relative to conventional fried potato products.

Additionally, there is a need for formed products, such as French fries, based on potatoes or other vegetables, and incorporating healthful non-potato vegetables, legumes and other ingredients such as whole grains, nuts, seeds, herbs, spices, and more. Further, there is a need to make healthful, tasty, and convenient products using whole and fresh ingredients, while maintaining moisture levels similar to those of traditional French fry products. There is a need to prepare and serve the products in a variety of shapes, to suit consumer preferences, including children. Finally, there is a need to reduce the final preparation time, for in-home or foodservice preparation, both as a means to reduce the fat content, and to increase convenience.

### SUMMARY OF THE INVENTION

The present invention meets all these needs by providing methods for preparing vegetable fries, shapes, or chips from one or more fresh or processed vegetable ingredients to produce a healthful and nutritionally-rich chopped and formed vegetable product. The product may be frozen or refrigerated and packed for wholesale, commercial, or retail sale.

The present invention also provides compositions of such prepared vegetable fries, shapes, or chips, which may comprise a plurality of types of vegetables, and which may further comprise seasonings, additional ingredients for flavoring, grains, seeds, nuts, fruits, dairy and meats including poultry and fish, and other all natural ingredients to create desired textures and flavor profiles. Furthermore, the present invention delivers the critical organoleptic and other visual product qualities (such as natural appearance, external texture, and internal texture) that are consistent with traditional French fry type products as demonstrated in technical sensory attribute testing with an independent research organization, with testers who have been screened and trained in accordance with ASTM STP 758: Guidelines for the Selection and Training of Sensory Panel Members.

The process disclosed entails preparing the ingredients to desired sizes, with washing, peeling, and cutting as appropriate, followed by blanching and/or parboiling for selected ingredients. The ingredients, individually or collectively, may be staged between different processing steps; any such staging step may comprise weighing, storage, cooling, or tempering. The ingredients may then be reduced in size, individually or in groups, to desired size ranges, which may vary for different ingredients, and which are herein referred to as ingredient particles or particulates, or simply as particles or particulates. Preferably the ingredients are cut into irregular shapes to produce a finished product with improved texture and mouth feel relative to the current art. Seasonings, flavorings, natural gum ingredients, starches and other ingredients may be introduced before or after the chopping, or during the blending. The ingredients are blended, preferably in a ribbon blender or a paddle blender to preserve particle size and shape without altering either. The mixed ingredients are then shaped using a forming plate or an extruder, depending on the shape of product desired. The pieces thus created may then be coated before being heated and having moisture removed, in a dehydrating step. This initial dehydrating step may also be omitted. The dehydrating may be dry or steam baking, and may be done in one or more phases of baking, or may be done in a drying tunnel or other equipment. Subsequent to dehydrating, the products may be cooled, and/or may be coated again, before being fried. The frying step may be omitted. After frying, the products may be further processed with a first dehydrating step, or a second dehydrating step if they were so treated before being fried. Following the chosen sequence of dehydrating and/or frying, all of which may be omitted in some embodiments of the invention, the products are rapidly cooled in a blast freezer, and then are packed for sale, with the type of packaging and quantity of products per package depending on whether that package is intended for commercial, wholesale, or retail sale.

The present invention may also allow for significantly faster preparation times versus some traditional French fry type products. This is true for product purchased frozen or refrigerated in retail stores with final preparation in the home as well as product that is sold to the various foodservice operators for final preparation and consumption on-premise or for take-away. In both instances, the present invention can be prepared in 10-30% less time than the leading brands.

Additionally, consumers wish to purchase such products in a variety of shapes, ranging from traditional French fries and steak fries, to waffle fries and shapes that are intended to appeal to children, such as smiley faces, alphabet shapes and animals.

### BRIEF DESCRIPTION OF THE DRAWINGS

In the drawings, like reference characters generally refer to the same steps of the method and composition throughout the different figures.
In the following description, various embodiments of the present invention are described with reference to the following drawings, in which:

FIG. 1 is a schematic diagram of the four phases of the method.

FIG. 2 is a schematic diagram of the first phase of the method, comprising the steps of Ingredient Preparation.

FIG. 3 is a schematic diagram of the second phase of the method, comprising the steps of Mixing Ingredients.

FIG. 4 is a schematic diagram of the third phase of the method, comprising the steps of Shaping and Cooking Products.

FIG. 5 is a schematic diagram of the fourth phase of the method, comprising the steps of Cooling and Packing Products.

FIG. 6 illustrates some of the possible shapes into which the prepared ingredient mixture may be formed.

FIG. 7 sets forth, in tabular form, the possible and preferred ranges of moisture content of the shaped pieces at various steps in the method disclosed.

### DETAILED DESCRIPTION OF THE INVENTION

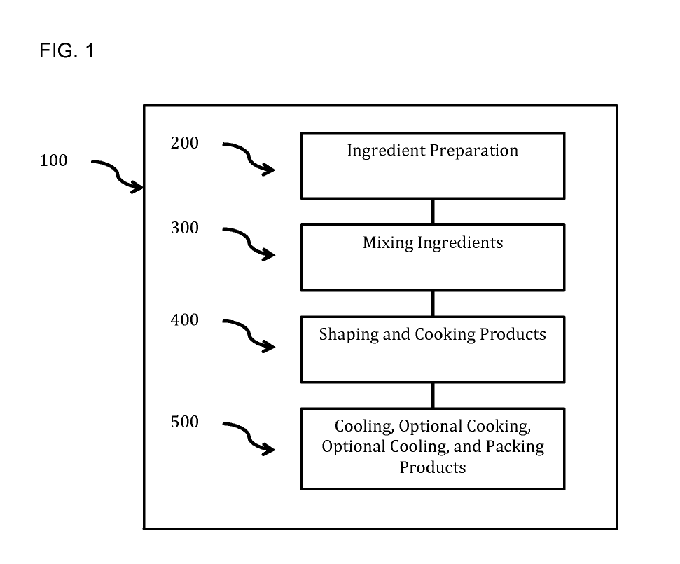

FIG. 1 illustrates a method 100 for making shaped and flavored vegetable fries or chips from one or more vegetables and other ingredients. The method includes the phases of Ingredient Preparation 200, Mixing Ingredients 300, Shaping and Cooking Products 400, and Cooling and Packing Products 500.

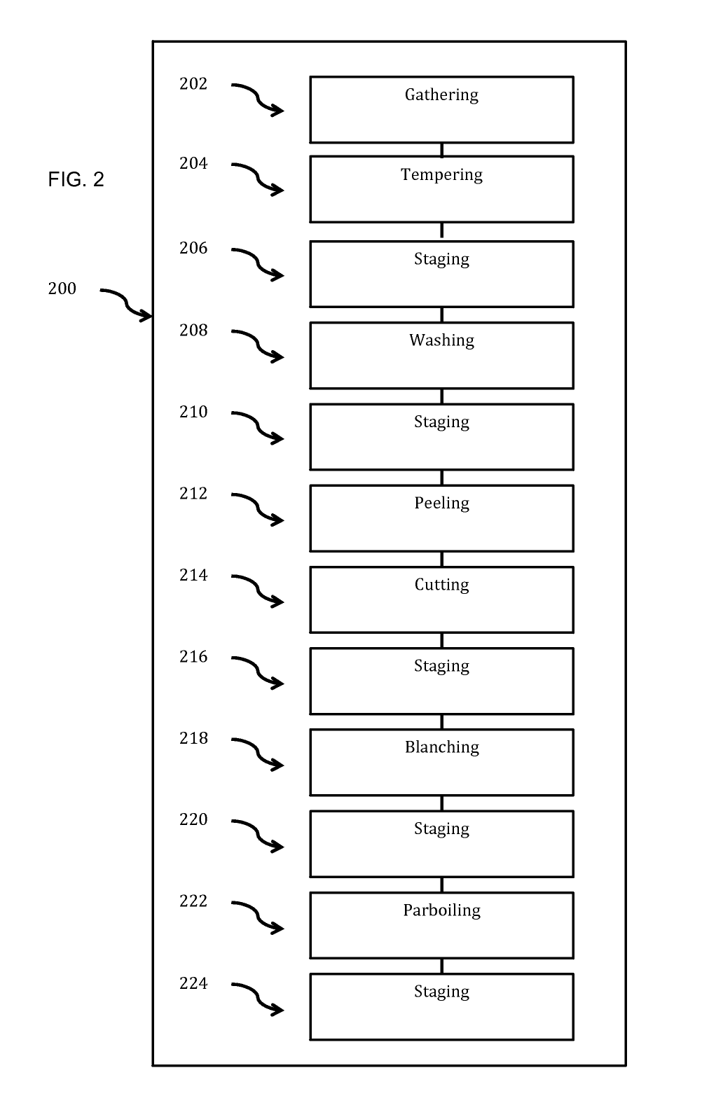

FIG. 2 illustrates the phase of Ingredient Preparation 200. Ingredient preparation 200 may comprise gathering ingredients 202, washing ingredients 208, peeling ingredients 212, cutting ingredients 214, blanching ingredients 218, parboiling ingredients 222, and staging the ingredients for final preparation 224. In certain embodiments of the invention, the ingredients may be tempered 204 and/or staged 206 between gathering ingredients 202 and washing ingredients 208, staged 210 between washing 208 and peeling 212, staged 216 between cutting ingredients 214 and blanching ingredients 218, and/or staged 220 between blanching ingredients 218 and parboiling ingredients 222. Staging may refer to any of placing the ingredients, individually or in groups, into one or more totes, refrigerating them, weighing them, drying them, or keeping the ingredients in a convenient location near the machine which will be handling them next.

In a preferred embodiment of the invention, one or more fresh vegetables are used. The multiple steps of ingredient preparation 200 may all be desirable in order to make the fresh ingredients ready to be combined. In other embodiments, one or more non-fresh vegetables may be used, for instance such ingredients may be canned, frozen, dried, dehydrated, or pureed. For some ingredients, it may be desirable to omit one or more of the steps of the phase of ingredient preparation 200. As will be obvious to one skilled in the art, multiple methods of ingredient preparation may be used.

Initially, ingredients are gathered 202. In some embodiments of the invention, other ingredients may be added to the one or more vegetables. Such ingredients may include, but are not limited to, any combinations of seasonings, natural binders, liquids, and specialty flavorings. For purposes of describing such a non-exhaustive list of categories of ingredients, and without limiting ingredients that may be included in any such categories, seasonings may include but is not limited to salt, pepper, herbs, and dairy; natural binders may include but is not limited to gum, calcium casseinate, egg proteins, guar, carrageenans, xantham gum, locust bean gum, starches, and egg albumen; liquids may include but is not limited to water, wine, and chicken or other stock; and specialty flavorings may include but is not limited to dairy, meats including poultry and fish, caramelized onions, sun-dried tomatoes, grains, seeds, nuts, and fruits. For any individual ingredient, it may be desirable to omit one or more of the steps of the phase of ingredient preparation 200. Ingredients that are seasonings, natural binders, liquids, or specialty flavorings may be prepared with multiple steps, or may be purchased commercially and used in the method of this invention described herein.

After gathering ingredients 202, some or all of the ingredients may be tempered 204, in which an ingredient that is frozen is moved from a freezer or other location where it is kept frozen, to a refrigerator or other location where it may be slowly warmed at temperatures slightly above freezing. In some embodiments of the invention, one or more frozen ingredients may be tempered 204 for up to 14 days, with a preferred time range of 4 days to 10 days, at a temperature range of 32° F.-41° F. The step of tempering 204 is used to achieve the desired temperature, texture, and functionality for further processing in one or more ingredients. Following the step of tempering 204, some or all of the ingredients may be staged 206 in preparation for washing 208.

In a preferred embodiment of the invention, each fresh vegetable ingredient is washed 208, may be peeled 212, and may be cut 214 into cut pieces. Certain of these steps may be applied to non-fresh vegetables or other ingredients, or may be omitted for certain ingredients for which a particular step is not needed, in particular but not limited to prepared spices or flavorings. The washing 208 may be done with hot or cold water, or using scrubbers or other tools to mechanically remove foreign particles. The peeling 212, while optional, may be done mechanically, by steam peeling, or by other means known in the art. The cutting step 214 may be intended to cut the one or more ingredients into relatively large pieces, to be subsequently processed or handled and then cut to a final size. For the cutting step 214, possible size ranges for cut size of vegetable pieces are 1.0-10.0 cm, while preferred sizes are 1.5 cm-3.0 cm. For different ingredients, there may be different shapes of cut pieces desired in the cutting step 214. In the cutting step 214, each ingredient can individually be cut to a preferred size, or more than one ingredient can be cut at the same time. The ingredients should be separately subjected to the cutting step 214 if different sizes of pieces are desired for different ingredients following the cutting step 214. The ingredients may be staged 216 after being washed 208, peeled 212, and/or cut 214.

After being staged 216, the ingredients may be blanched 218, a goal of which is to preserve freshness and color of the ingredients, by being placed, individually or in sets of more than one ingredient, into hot or boiling water for a period of time between 5 and 60 seconds, preferably for 10 to 40 seconds. The water for blanching should be boiling at approximately 212° F. In some embodiments of the invention, the blanching could be carried out in water held at elevated atmospheric pressure, with pressure ranging from 2 to 50 pounds per square inch (“psi”), and preferably between 10 and 50 psi. Following the time in the hot or boiling water, the blanching 218 of the ingredients is completed by quickly placing the ingredients into cold water, which may be done for a period of time between 5 seconds and 120 seconds, preferably for 10 to 60 seconds. The water for cooling should be between 30 and 40° F., and preferably between 32 and 38° F. The ingredients may then be staged 220 by being allowed to cool for some length of time between 1 and 20 minutes, preferably for 5 to 15 minutes.

The ingredients may be parboiled 222 by being placed, individually or in sets of more than one ingredient, into boiling water for a period of time between 1 and 6 minutes, preferably for 2 to 3 minutes. The water for parboiling should be boiling at approximately 212° F. In some embodiments of the invention, the parboiling could be carried out in water held at elevated atmospheric pressure, with pressure ranging from 2 to 50 pounds per square inch (“psi”), and preferably between 10 and 50 psi.

After being parboiled 222, the ingredients may be staged 224, in preparation for the phase of Mixing Ingredients 200. It will be readily understood by one of skill in the art that not every ingredient will need all of these steps for preparation; by way of example without limiting the forgoing, some seasonings, natural binders, or liquids may be ready to use in mixing together with other ingredients.

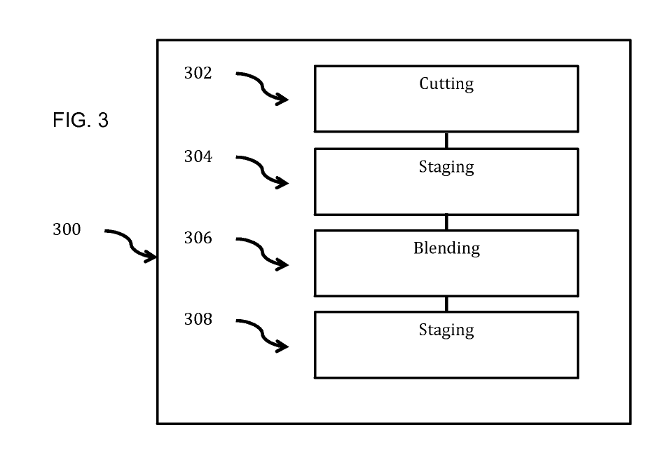

FIG. 3 illustrates the phase of Mixing Ingredients 300, in which the ingredients are combined together into an ingredient mixture. One or more ingredients are reduced in size in a cutting step 302. The cutting step 302 may be carried out in a cutting or chopping bowl, which may have a blade speed ranging from 0 to 6000 rotations per minute (rpm), with a bowl rotation speed of 10-20 rpm. As will be obvious to one skilled in the art, other means of reducing the ingredients from their original size to the preferred particulate size may be used, including but not limited to grinding. In a preferred embodiment, each vegetable ingredient is separately passed through the cutting step 302. In some embodiments, more than one vegetable ingredient may be cut, chopped, ground, or otherwise reduced in size in the cutting step 302 at the same time. Preferably, the ingredients are cut or otherwise reduced into shapes that are irregular in three dimensions.

Preferred size ranges may vary for each vegetable ingredient, and some specialty ingredients, for final particulate size after the cutting step 302. For potatoes, the preferred range of particulate sizes is 0.2-0.8 centimeters (cm), and the range of possible particulate sizes is 0.02-2.0 cm. For carrots, the preferred range of particulate sizes is 0.1-0.8 cm, while the range of possible particulate sizes is 0.005-2.0 cm. For broccoli, the preferred range of particulate sizes is 0.05-0.8 cm, while the range of possible particulate sizes is 0.05-2.0 cm. For other vegetable ingredients, the preferred range of particulate sizes is 0.3-0.8 cm, while the range of possible particulate sizes is 0.005-2.0 cm. For some ingredients, especially non-vegetable ingredients such as seasonings and natural binders, the particulate sizes may be much smaller.

After the cutting step 302, the ingredients may be staged 304. This may include a rest period of, in preferred embodiments, up to 15 minutes with the ingredients being held at ambient temperature of 50° F.-80° F. If the ingredients are held for longer than 15 minutes, they should be stored at refrigeration temperatures of 33° F.-44° F., preferably 36° F.-44° F., for 15 minutes to 24 hours. The ingredients may also be combined into containers for or during this staging 304, and then moved to the blending step 306.

All of the ingredients are moved to the blending step 306 for blending to combine the ingredients into an ingredient mixture with the desired density, viscosity, and moisture content, without reducing the size of the individual particulate elements of each ingredient. The blender should, preferably, be capable of 5 to 100 rpm, and preferably will reduce vegetable ingredient particulate size by less than 3%. In some embodiments it may be acceptable to have the ribbon blender, paddle blender, or other blender reduce vegetable ingredient particulate size by as much as 10%. In some embodiments of the invention, the desired ingredient mixture will have a viscosity in the range of 400 to 1500 mPas and preferably 600 to 1000 milli-Pascal-seconds (mPas) as measured with a viscometer such as a Brookfield Viscometer or comparable instrument. The desired ingredient mixture will also have moisture content, as measured by the percent of the ingredient mixture that is moisture, in the range of 40% to 85%, and preferably 45% to 80%, for ingredient mixtures that are to be Shaped and Cooked 400 with a step of Heated Dehydration 406 prior to Frying 410.

After the blending step 306, the ingredients may be staged 308. This may include a rest period of, in preferred embodiments, up to 15 minutes with the ingredients being held at ambient temperature of 50° F.-80° F. If the ingredients are held for longer than 15 minutes, they should be stored at refrigeration temperatures of 33° F.-44° F., preferably 36° F.-44° F., for 15 minutes to 24 hours. The ingredients may be held in the blender or in containers for or during this staging 308, and then moved to phase of shaping and cooking 400.

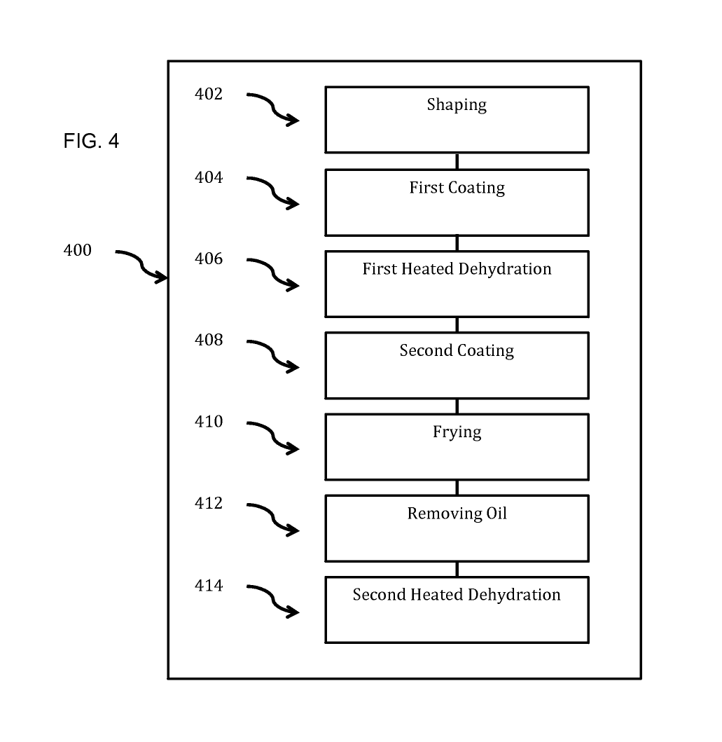

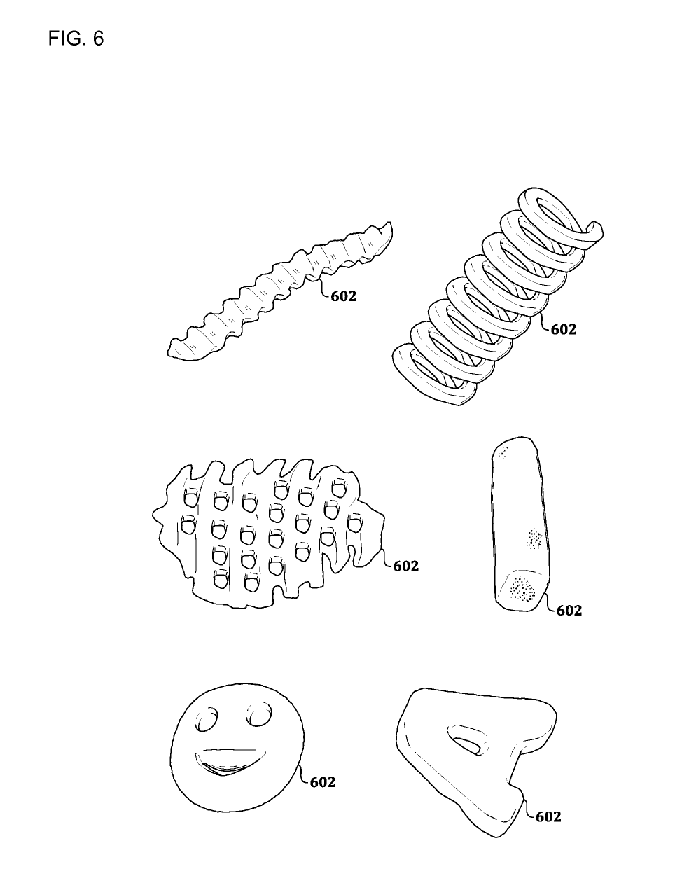

FIG. 4 illustrates the phase of Shaping and Cooking Products 400. The ingredient mixture is shaped 402 into shaped pieces 602 of one or more particular sizes and shapes. In some embodiments of the invention, a forming plate may be used to create shaped pieces 602 shaped as French fries, steak fries, waffle fries, hash browns, tots, curly fries, smiley faces, animal silhouettes or faces, or other shapes, including but not limited to those illustrated in FIG. 6. A forming plate may be used, or other comparable instrument capable of up to 80 stamps per minute at variable pressure in the range of 10 to 200 psi, and preferably in the range of 50 to 150 psi, such as those made by Formax or Koppens, or other similar devices. In other embodiments, a variable pressure extruder may be used to create shaped pieces 602 shaped as French fries, string fries, curly fries, steak fries, nuggets, or other shapes. When using an extruder, the pressure used may be in the range of 10 to 200 psi, and preferably is in the range of 50 to 150 psi. Other methods of forming or shaping the pieces may be used, as is apparent to one skilled in the art.

During the step of shaping 402, shapes should be made into sizes that adults and children are familiar with, and are comfortable eating in up to several bites. For instance, French fries may be shaped in the size range of 3.0-10.0 cm×0.2-1.5 cm×0.2-1.5 cm (length×width×depth), and preferably in the range of 5.0-9.0 cm×0.6-1.2 cm×0.6-1.2 cm. The shaped pieces 602 should have viscosity in the range of 400 to 1500 mPas, and preferably 600 to 1000 mPas. In embodiments of the invention with sequences of cooking steps, as discussed below, that include a Dehydrating step 406 prior to Frying 410, the shaped pieces 602 should have moisture content in the range of 40% to 85%, and preferably 45% to 80%. In embodiments of the invention with sequences of cooking steps that do not include a Dehydrating step 406 prior to Frying 410, the shaped pieces 602 should have moisture content in the range of 40% to 85%, and preferably 45% to 73%.

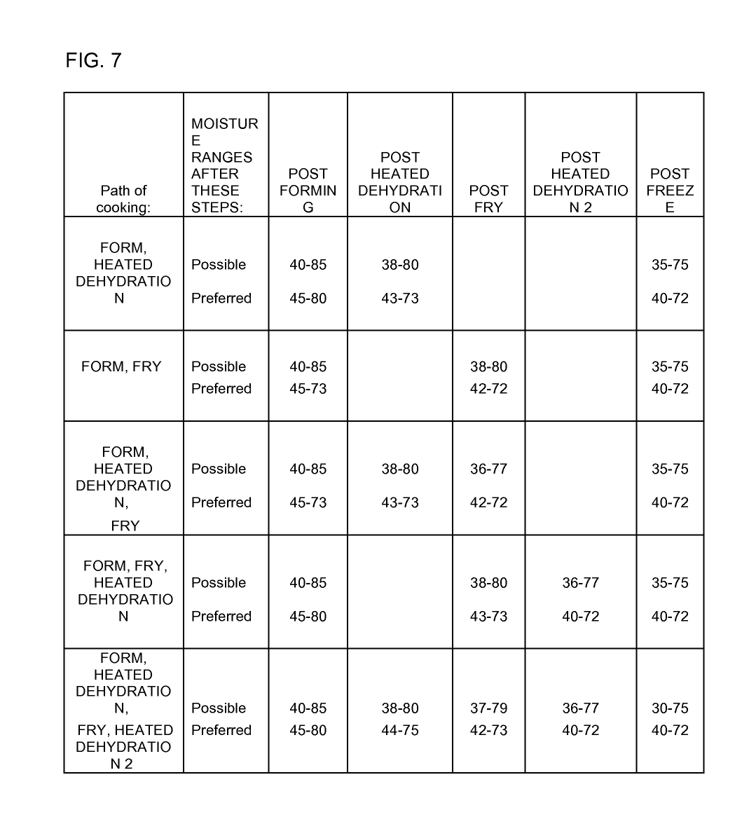

In the steps of the Shaping and Cooking Products 400 phase that relate to cooking the shaped pieces 602, the cooking may follow several paths in different embodiments of the invention, depending on the product being made, its ingredients, and whether it is intended to be sold to retail consumers or to foodservice businesses for preparation and sale to customers in ready-to-eat form. Depending on those factors, the shaped pieces 602 may be processed for cooking with one or more cooking steps, as 1) Heated Dehydration 406 alone, 2) Frying 410 alone, 3) Heated Dehydration 406 then Frying 410, 4) Frying 410 then Heated Dehydration 414, 5) Heated Dehydration 406, then Frying 410, then Heated Dehydration 414, or 6) no Heated Dehydration or Frying, instead going directly from shaping 402 to cooling 502; and the above sequences of cooking steps may have a first coating step 404 and/or a second coating step 408 and/or a step of removing excess oil 412 as well, including the possibility of processing the ingredient mixture with shaping 402 to create shaped pieces 602, treating them with a first coating step 404 and possibly a second coating step 408, and then cooling 502 the shaped pieces 602. In different embodiments of the invention, with different sequences of cooking steps, the possible and preferred ranges of moisture content for the ingredient mixture when mixed and after each of the chosen cooking steps may vary, as may the time and temperature ranges selected in such cooking steps, as will be readily apparent to one skilled in the art. FIG. 7 provides details of possible and preferred ranges of moisture content for different embodiments of the invention with different sequences of such cooking steps.

Following shaping 402 the ingredient mixture into shaped pieces 602, the shaped pieces 602 may be treated with a first coating step 404. The first coating step 404 is expected to not alter the size of the shaped pieces 602 significantly. In preferred embodiments of the invention, the pieces are coated 404 with a coating mixture comprising some or all of dextrin, tapioca starch, rice starch, corn starch, potato starch, and other ingredients. The goal of this first coating step 404 is to contribute to an appealing crispy texture on the outside of the finished and prepared pieces, while reducing the fat content of the pieces relative to traditional French fries and the prior art. Other coating mixtures may be used to meet this goal. The first coating step 404 may preferably be carried out by misting the coating mixture onto the pieces, sprayed at a pressure of 0-30 psi, or preferably at 5-15, or the coating mixture may be applied by other means, including but not limited to immersion in the coating mixture, or a waterfall-type application of the coating. The first coating step 404 may be carried out in a machine at a temperature of 35° F.-70° F., or preferably at 35° F.-60° F., with the targeted internal temperature of the shaped pieces 602 of 20° F.-65° F., or preferably 25° F.-50° F. The coating mixture may be applied for up to 10 seconds, though in preferred embodiments, it may be applied for 1.0 seconds or less time. The coating mixture may have an approximate viscosity of 1-5 centipoids, or in preferred embodiments of the invention, 2-4 centipoids. The coating mixture applied may be measured as a density, in mg per unit area, with a range of 0.001 mg coating mixture per square centimeter (mg/cm2) of shaped pieces 602, up to 2.0 mg/cm2. Following the first coating step 404, the pieces must rest so that the coating mixture has time to dry. This may be done for 0-60 seconds, or in preferred embodiments of the invention, for 2-40 seconds.

Following the first coating step 404 and a rest period of up to 30 seconds to allow the coating mixture to dry on the pieces 602, the shaped pieces 602 may be treated with a first step of Heated Dehydration 406, referred to here as a first dehydrating step 406 or simply first dehydrating 406 for brevity. A goal of the first dehydrating step 406 is to create a firm outside, referred to as an external wall or crust. The first dehydrating 406 may be carried out for 0-20 minutes, and in a preferred embodiment of the invention, the first dehydrating 406 may be for 30 seconds-10 minutes. The first dehydrating 406 may be at a temperature in the range of 200° F.-500° F., to create a target internal temperature of the pieces 602 in the range of 40° F.-200° F. In a preferred embodiment, the first dehydrating 406 temperature may be in the range of 300° F.-450° F., to create a target internal temperature of the pieces 602 in the range of 100° F.-200° F. A goal of the first dehydrating step 406 is to create a tougher external wall or crust on the pieces 602, which creates additional consumer appeal in appearance and in mouth feel, and helps to seal in moisture, which contributes to the mouth feel of the finished product, and helps to reduce fat content by reducing frying time in embodiments of the invention in which the shaped pieces 602 are fried.

The first dehydrating step 406 may be carried out by dry baking or steam baking in a conventional oven, or in a drying tunnel, a belt dryer, a conveyor dryer, or other device for removing moisture, for instance in an industrial Koppens oven, an Imtech drying tunnel, or a Bühler conveyor dryer. In some embodiments of the present invention, the equipment used for heated dehydration may have more than one zone of control over parameters such as temperature, duration of processing, and belt speed, to enable better dehydration and crust formation, and control thereover in the independent zones of dehydration. Following the first dehydrating step 406, if the cooking process is to include a Frying step 410, the target moisture content of the shaped pieces 602 is in the range of 38% to 80%, and preferably 43% to 73%. If the embodiment of the invention includes a cooking process with no Frying step 410 after this dehydrating step 406, the target moisture content of the shaped pieces 602 after the dehydrating step 406 is in the range of 38% to 80%, and preferably 43% to 73%.

Following the dehydrating step 406, the shaped pieces 602 may be treated with a second coating step 408. In preferred embodiments of the invention, the pieces 602 are given a second coating 408 with a coating mixture comprising some or all of dextrose, tapioca starch, rice starch, potato starch, corn starch, and other ingredients, which may be the same as the coating mixture used in the first coating step 404. The goal of this second coating step 408 is to contribute to an appealing crispy texture on the outside of the finished and prepared pieces, while reducing the fat content of the shaped pieces 602 relative to traditional French fries and the prior art. Other coating mixtures may be used to meet this goal. The second coating step 408 may preferably be carried out by misting the coating mixture onto the pieces, sprayed at a pressure of 0-30 psi, or preferably at 5-15, or the coating mixture may be applied by other means. The second coating step 408 may be carried out in a machine at a temperature of 35° F.-70° F., or preferably at 35° F.-60° F., with the targeted internal temperature of the shaped pieces 602 of 40° F.-65° F., or preferably 30° F.-50° F. The coating mixture may be applied for up to 10 seconds, though in preferred embodiments, it may be applied for 1.0 seconds or less time. The coating mixture may have an approximate viscosity of 1000-4000 mPas, or in preferred embodiments of the invention, 1500-3000 mPas. The coating mixture applied may be measured as a density, in mg per unit area, with a range of 0.001 mg coating per square centimeter (mg/cm2) of shaped pieces 602, up to 2.0 mg/cm2. Following the second coating step 408, the pieces must rest so that the coating mixture has time to dry. This may be done for 0-60 seconds, or in preferred embodiments of the invention, for 2-40 seconds.

Following the second coating step 408 and a rest period of up to 60 seconds to allow the coating mixture to dry on the pieces 602, the shaped pieces 602 may be fried 410. The frying 410 may be carried out for 0-90 seconds, and in a preferred embodiment of the invention, the duration may be for 5-35 seconds. The frying 410 may be at a temperature in the range of 300° F.-400° F., to create a target internal temperature of the shaped pieces 602 in the range of 180° F.-230° F. In a preferred embodiment, the frying temperature may be in the range of 350° F.-400° F., to create a target internal temperature of the pieces in the range of 180° F.-220° F. Following the frying 410, the shaped pieces 602 should have moisture content in the range of 36% to 77%, and preferably in the range of 42% to 73%, if the sequence of cooking steps used in the particular embodiment of the invention does not include a second heated dehydration step 414 after the frying 410. If the shaped pieces 602 are to follow a cooking path of frying 410 then a heated dehydration step 414, moisture content after frying 410 should be in the range of 38%-80%, and preferably 43%-73%. If the shaped pieces 602 are to follow a cooking path of heated dehydration 406, then frying 410, and then a second heated dehydration step 414, moisture content after frying 410 should be in the range of 36%-77%, and preferably 42%-72%. The frying oil used may be an oil mixture comprising some or all of canola, olive, cottonseed, sunflower, vegetable, and other oils. In a preferred embodiment of the invention, the frying oil is canola oil or sunflower oil. A goal of the frying step is to create a product with a fat percentage between 2%-15%. A further goal of the frying step 410 is to create a tougher external wall on the pieces, which creates additional consumer appeal in appearance and in mouth feel, and helps to provide a tender internal texture, which contributes to the mouth feel of the finished product, and can reduce fat content by reducing frying time or fat or oil required in other cooking methods in the final preparation step 512.

Following Frying 410, the shaped pieces 602 may have excess oil removed from them in a step of removing excess oil 412. This can be implemented by, typically, blowing air over the shaped pieces 602, or in some embodiments, by placing them in a large centrifuge or strainer, or by other means.

The shaped pieces 602 may be treated with a second step of Heated Dehydration 414, referred to here as a dehydrating step 414 or dehydration 414 for brevity. The second dehydrating 414 may be carried out for 0-20 minutes, and in a preferred embodiment of the invention, the second dehydrating 414 may be carried out for 30 seconds-10 minutes. The second dehydrating 414 may be at a temperature in the range of 200° F.-500° F., to create a target internal temperature of the pieces in the range of 60° F.-200° F. In a preferred embodiment, the second dehydrating temperature 414 may be in the range of 300° F.-450° F., to create a target internal temperature of the pieces in the range of 100° F.-180° F. A goal of the second dehydrating step 414 is to crisp the exterior of the shaped pieces 602 to create a tougher external wall or crust on the pieces, which creates additional consumer appeal in appearance and in mouth feel. Additional goals of this second dehydrating step 414 are to further reduce the moisture content of the shaped pieces 602, and to retain moistness, which contributes to the mouth feel and interior tenderness of the finished product, and helps to reduce fat content by reducing frying time in embodiments of the invention in which the shaped pieces 602 are fried.

The second dehydrating 414 may be carried out by dry baking or steam baking in a conventional oven, or in a drying tunnel, a belt dryer, a conveyor dryer, or other device for removing moisture, for instance in an industrial Koppens oven, an Imtech drying tunnel, or a Bühler conveyor dryer. In some embodiments of the present invention, the equipment used for heated dehydration may have more than one zone of control over parameters such as temperature and belt speed, to enable better dehydration and crust formation. Following the second dehydrating 414, the target moisture content of the shaped pieces 602 is in the range of 36% to 77%, and preferably 40% to 72%.

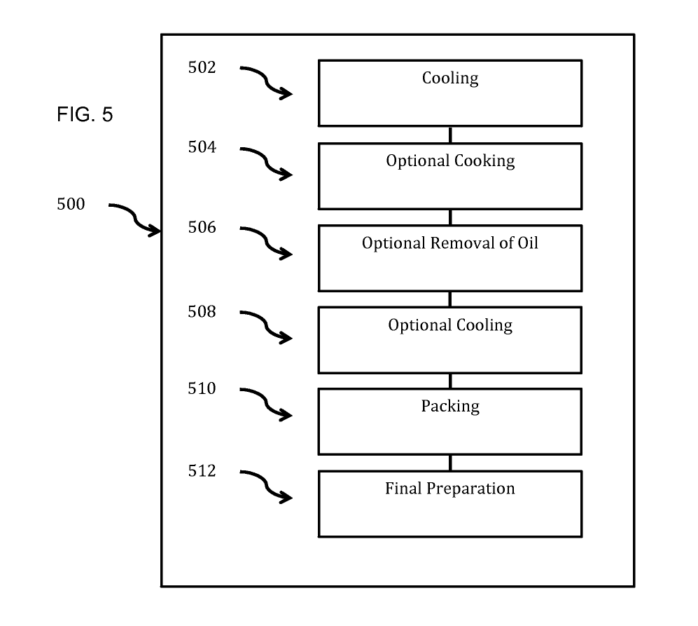

FIG. 5 illustrates the phase of Cooling, Optional Cooking, Optional Cooling, and Packing Products 500, in which the shaped pieces 602 are cooled or frozen in a cooling 502 step, may optionally be cooked in an optional cooking 504 step, may optionally have oil removed in an optional oil removal 506 step, may optionally be cooled or frozen in an optional cooling step 508, and thereafter are packaged for sale in a packing 510 step.

In a preferred embodiment of the invention, the shaped pieces 602 are cooled 502 in a blast freezer. In other implementations of the cooling 502 step, the shaped pieces 602 may be slowly frozen, or may be cooled to refrigerated temperatures, in the range of 32° F.-42° F., and maintained in refrigeration. Using a blast freezer for the cooling step 502, the machine may be set to a temperature in the range of −20° F.-32° F., and preferably to a temperature in the range of 20° F.-32° F. The shaped pieces 602 may be frozen for 10-60 seconds, and preferably for 30-50 seconds. If the shaped pieces 602 are cooled 502 in a slow freezer, the machine may be set to a temperature in the range of −20° F.-32° F., and preferably to a temperature in the range of 10° F.-30° F., and the shaped pieces 602 may be frozen for 30 minutes-48 hours, and preferably for 45 minutes-4 hours. The target internal temperature for the shaped pieces 602 at this step is −20° F.-30° F., and preferably 16° F.-22° F. Following the cooling step 502, the shaped pieces 602 should have moisture content in the range of 30% to 75%, and preferably 40% to 72%, as set forth in FIG. 7.

Following the step of cooling 502 the shaped pieces 602, the shaped pieces 602 may be subjected to a step of optional cooking 504. The optional cooking 504 may be implemented by frying the shaped pieces 602, or as will be clear to one skilled in the art, by other means now known or later discovered, including but not limited to heated dehydration. If the optional cooking 504 is implemented as frying, the optional cooking 504 may be carried out, in some embodiments of the invention, for durations of time and at temperatures and in oil mixtures that are the same or similar to those disclosed above for the frying 410 step. Alternatively, as will be apparent to one skilled in the art, other ranges of frying time and frying temperature may be desirable, to bring about a desired shaped pieces 602 product. Likewise, in embodiments of the invention in which the optional cooking 504 step is carried out by frying the shaped pieces 602, the target ranges for moisture content and fat content of the shaped pieces 602 may be desired to be the same or similar to those desired in the shaped pieces 602 after the step of frying 410, or as will be apparent to one skilled in the art, may be different to bring about the desired finished shaped pieces 602 product. A further goal of the optional cooking step 504 is to create a tougher external wall on the shaped pieces 602, which creates additional consumer appeal in appearance and in mouth feel, and helps to provide a tender internal texture, which contributes to the mouth feel of the finished product, and can reduce fat content by reducing frying time or fat or oil required in other cooking methods in the final preparation step 512.

Following the step of cooling 502 the shaped pieces 602, and after any treatment or processing of the shaped pieces 602 by implementation of optional cooking 504, the shaped pieces 602 may be subjected to a step of optional removal of oil 506. This can be implemented by, typically, blowing air over the shaped pieces 602, or in some embodiments, by placing them in a large centrifuge or strainer, or by other means.

Following the step of cooling 502 the shaped pieces 602, and following any optional cooking 504 and/or optional removal of oil 506 if either or both of said optional cooking 504 and optional removal of oil 506 are implemented in an embodiment of the invention, the shaped pieces 602 may be subjected to a step of optional cooling 508. As will be apparent to one skilled in the art, the optional cooling 508 step may be implemented with the same or similar equipment and the same or similar ranges of time and temperature as may be implemented for the cooling 502 step, and the optional cooling 508 step may be intended to achieve the same or similar target internal temperatures and moisture content of the shaped pieces 602 as the cooling 502 step is, as disclosed above. Alternatively, in some embodiments of the invention implementing the optional cooling step 508, it may be desirable to use different equipment and ranges of time and temperature, and/or it may be desirable to achieve different ranges of target internal temperatures and moisture content of the shaped pieces 602, than are described above for the cooling 502 step.

Following the step of cooling 502 the shaped pieces 602, and following any optional cooking 504 and/or optional removal of oil 506 and/or optional cooling 508, the shaped pieces 602 are packed 510 for sale. Several packaging options are available, including but not limited to bags, boxes, and bulk, and they are differently preferred for different intended avenues of sale. Possible sizes for packing 510 range from trial sizes, of approximately 2 to 3 ounces, retail sales packaging of 8-32 ounces, club store packing of 1-5 pounds, and food service packaging of 1-50 pounds. During packing 510 and later transport of shaped pieces 602 that were frozen in the cooling step 502, the target internal temperature for the shaped pieces 602 is −20° F.-30° F., and preferably 16° F.-22° F. For shaped pieces 602 that were refrigerated in the cooling step 502, the packing 510 may incorporate “Modified Air Packaging” as it is known to those skilled in the art, or some other means of preserving freshness during the shelf life of the shaped pieces 602.

The shaped pieces 602 are packed 510 in packaging material. Such packaging material may be marked with varying instructions for final preparation 512 depending on whether the package was sold to a retail consumer, or to a restaurant or other foodservice provider. For preparation by consumers, possible final preparation 512 instructions include instructions for baking, in a preferred embodiment at 450° F. for 18-23 minutes, and in other embodiments at 350° F.-475° F. for 6-30 minutes. For preparation by foodservice establishments, preparation instructions may include similar instructions for baking, such as in a preferred embodiment at 450° F. for 18-23 minutes, and in other embodiments at 350° F.-475° F. for 6-30 minutes. Instructions for final preparation 512 by foodservice establishments may also include frying, in a preferred embodiment of the invention at 375° F. for 45-150 seconds, and in other embodiments at 350° F.-400° F. for 20-200 seconds.

Certain embodiments of the present invention were described above. It is expressly noted that the present invention is not limited to those embodiments, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, I claim:

1. A method for making shaped and flavored pre-cooked food items, comprising:
preparing one or more ingredients, comprising the steps of:
gathering said ingredients,
washing said ingredients,
peeling said ingredients,
cutting said ingredients, and
staging said ingredients for final preparation;
mixing a plurality of ingredients to form an ingredient mixture,
comprising the steps of:
reducing one or more ingredients in size, and
blending said plurality of ingredients together;
shaping said ingredient mixture into shaped pieces;
cooling said shaped pieces; and
packing said shaped pieces.

2. The method of claim 1, in which preparing said ingredients further comprises tempering said ingredients between gathering said ingredients and washing said ingredients.

3. The method of claim 1, in which preparing said ingredients further comprises staging said ingredients between gathering said ingredients and washing said ingredients.

4. The method of claim 1, in which preparing said ingredients further comprises staging said ingredients between washing said ingredients and peeling said ingredients.

5. The method of claim 1, in which preparing said ingredients further comprises blanching said ingredients between cutting said ingredients and staging said ingredients for final preparation.

6. The method of claim 5, in which preparing said ingredients further comprises staging said ingredients between cutting said ingredients and blanching said ingredients.

7. The method of claim 1, in which preparing said ingredients further comprises parboiling said ingredients between cutting said ingredients and staging said ingredients for final preparation.

8. The method of claim 7, in which preparing said ingredients further comprises staging said ingredients between cutting said ingredients and parboiling said ingredients.

9. The method of claim 1, in which mixing said plurality of ingredients further comprises staging said plurality of ingredients between reducing one or more ingredients in size and blending said plurality of ingredients together.

10. The method of claim 1, in which mixing said plurality of ingredients further comprises staging said plurality of ingredients between blending said plurality of ingredients together and shaping said ingredient mixture into shaped pieces.

11. The method of claim 1, in which making shaped and flavored pre-cooked food items further comprises processing said shaped pieces with one or more cooking steps between the step of shaping said ingredient mixture into shaped pieces and the step of cooling said shaped pieces.

12. The method of claim 11, in which said one or more cooking steps comprises treating said shaped pieces with a first coating step.

13. The method of claim 11, in which said one or more cooking steps comprises treating said shaped pieces with a first heated dehydration.

14. The method of claim 11, in which said one or more cooking steps comprises treating said shaped pieces with a second coating step.

15. The method of claim 11, in which said one or more cooking steps comprises frying said shaped pieces.

16. The method of claim 15, in which said one or more cooking steps comprises removing excess oil from said shaped pieces.

17. The method of claim 11, in which said one or more cooking steps comprises treating said shaped pieces with a second heated dehydration.

18. The method of claim 1, in which making shaped and flavored pre-cooked food items further comprises processing said shaped pieces with a cooking step between the step of cooling said shaped pieces and the step of packing said shaped pieces.

19. The method of claim 18, in which making shaped and flavored pre-cooked food items further comprises removing excess oil from said shaped pieces.

20. The method of claim 1, in which making shaped and flavored pre-cooked food items further comprises processing said shaped pieces with an optional cooling step between the step of cooling said shaped pieces and the step of packing said shaped pieces.

21. Apparatus for making shaped and flavored pre-cooked food items, comprising:
means for preparing one or more ingredients, further comprising:
means for gathering said ingredients,
means for washing said ingredients,
means for peeling said ingredients,
means for cutting said ingredients, and
means for staging said ingredients for final preparation;
means for mixing a plurality of ingredients to form an ingredient mixture, further comprising:
means for reducing one or more ingredients in size, and
means for blending said plurality of ingredients together;
means for shaping said ingredient mixture into shaped pieces;
means for cooling said shaped pieces; and
means for packing said shaped pieces.

22. The apparatus of claim 21, further comprising means for tempering said ingredients between gathering said ingredients and washing said ingredients.

23. The apparatus of claim 21, further comprising means for staging said ingredients between gathering said ingredients and washing said ingredients.

24. The apparatus of claim 21, further comprising means for staging said ingredients between washing said ingredients and peeling said ingredients.

25. The apparatus of claim 21, further comprising means for blanching said ingredients between cutting said ingredients and staging said ingredients for final preparation.

26. The apparatus of claim 25, further comprising means for staging said ingredients between cutting said ingredients and blanching said ingredients.

27. The apparatus of claim 21, further comprising means for parboiling said ingredients between cutting said ingredients and staging said ingredients for final preparation.

28. The apparatus of claim 27, further comprising means for staging said ingredients between cutting said ingredients and parboiling said ingredients.

29. The apparatus of claim 21, further comprising means for staging said plurality of ingredients between reducing one or more ingredients in size and blending said plurality of ingredients together.

30. The apparatus of claim 21, further comprising means for staging said plurality of ingredients between blending said plurality of ingredients together and shaping said ingredient mixture into shaped pieces.

31. The apparatus of claim 21, further comprising means for cooking said shaped pieces between shaping said ingredient mixture into shaped pieces and cooling said shaped pieces.

32. The apparatus of claim 31, further comprising means for treating said shaped pieces with a first coating.

33. The apparatus of claim 31, further comprising means for treating said shaped pieces with a first heated dehydration.

34. The apparatus of claim 31, further comprising means for treating said shaped pieces with a second coating.

35. The apparatus of claim 31, further comprising means for frying said shaped pieces.

36. The apparatus of claim 35, further comprising means for removing excess oil from said shaped pieces.

37. The apparatus of claim 31, further comprising means for treating said shaped pieces with a second heated dehydration.

38. The apparatus of claim 21, further comprising means for treating said shaped pieces with cooking between cooling said shaped pieces and packing said shaped pieces.

39. The apparatus of claim 38, further comprising means for removing excess oil from said shaped pieces.

40. The apparatus of claim 21, further comprising means for treating said shaped pieces with an optional cooling step between the step of cooling said shaped pieces and the step of packing said shaped pieces.

41. A method for making shaped and flavored pre-cooked food items, comprising:
preparing one or more ingredients for mixing said ingredients to form an ingredient mixture;
mixing said ingredients to form an ingredient mixture;
shaping said ingredient mixture into shaped pieces;
cooking said shaped pieces;
cooling said shaped pieces;
further cooking said shaped pieces;
further cooling said shaped pieces; and
packing said shaped pieces.
